(19) United States
(12) Patent Application Publication
(10) Pub. No.: US 2010/0283589 A1
(43) Pub. Date: Nov. 11, 2010

(54) IMAGE PROCESSING SYSTEM, IMAGE CAPTURE DEVICE AND METHOD THEREOF

(75) Inventors: Jun Kawai, Kawasaki (JP); Katsutoshi Yano, Kawasaki (JP); Toshiaki Gomi, Kawasaki (JP); Hiroshi Yamada, Kawasaki (JP)

Correspondence Address: Fujitsu Patent Center;Fujitsu Management Services of America, Inc., 2318 Mill Road, Suite 1010, Alexandria, VA, 22314, US

(73) Assignee: FUJITSU LIMITED, Kawasaki-shi (JP)

(21) Appl. No.: 12/774,920

(22) Filed: May 6, 2010

(30) Foreign Application Priority Data
May 8, 2009 (JP) 2009-113931

(51) Int. Cl. B60Q 1/00; G06K 9/36

(52) U.S. Cl. 340/425.5; 382/284

(57) ABSTRACT

An image processing system including a display apparatus, a plurality of image capture units and an image processing apparatus is provided. The plurality of image capture units each include a camera capturing an image data, a storage unit storing segment information for identifying each of segments divided from the image data, and importance degrees calculated for the segments, an image compressing unit compressing each of the segments of the image data, and a transmitting unit transmitting the compressed image data to the image processing apparatus. The image processing apparatus includes a network interface unit inputting the compressed image data, an image generating unit generating a combined image data based on the compressed image data, and a transmitting unit transmitting the combined image data to the display apparatus, and the display apparatus includes a receiving unit receiving the combined image data and a display unit displaying the combined image data.

### CROSS-REFERENCE TO RELATED APPLICATIONS

This application is based upon and claims the benefit of priority of the prior Japanese Patent Application No. 2009-113931, filed on May 8, 2009, the entire contents of which are incorporated herein by reference.

### FIELD

Embodiments described herein relate to an image processing system and method that captures images of surrounding parts of an object using a plurality of image capture apparatuses, combines the captured images, and displays a resultant image on a display apparatus.

### BACKGROUND

There has been proposed an apparatus that allows a plurality of cameras mounted on a vehicle to shoot surroundings of the vehicle which correspond to blind angles for a driver and displays captured images on a display apparatus in the vehicle to assist the driver in driving safely.

However, when the resolution of each camera is increased in order to display a higher-definition image, the amount of data transmitted from the cameras to an image processing apparatus that processes images captured through the cameras is remarkably increased. In addition, if the number of cameras mounted on the vehicle is increased, the amount of data transmitted from the cameras to the image processing apparatus is similarly increased remarkably. Accordingly, in some cases, the amount of data that can be transmitted is limited by the bandwidth of a transmission path connecting each camera to the image processing apparatus.

Japanese Laid open Patent Application Publication No. 2000-83193 and No. 10-136345 discuss techniques of reducing the amount of data transmitted from an image capture device or a camera control device to an image receiving device. In the technique discussed in Japanese Laid open Patent Application Publication No. 2000-83193, the image receiving device generates layout information regarding an image to be generated and transmits the information to image capture devices. Each image capture device processes captured image data so as to crop a captured image in accordance with the received layout information and transmits the resultant image data to the image receiving device. In the technique discussed in Japanese Laid open Patent Application Publication No. 10-136345, each camera control device detects an image capturing direction and a zoom magnification of a camera and transforms an image captured through the camera into an image with a desired resolution at a desired frame rate. The resultant image is transmitted from the camera control device to a terminal. The terminal combines images transmitted from the camera control devices and displays the resultant image on a monitor.

### SUMMARY

According to an embodiment of the invention, an image processing system includes a display apparatus displaying image data, a plurality of image capture units mounted on a vehicle and capturing images of surroundings of a vehicle and an image processing apparatus connected with the plurality of image capture units via a network in the vehicle to generate a combined image data based on a plurality of image data captured by the image capture units, and connected with the display apparatus. The plurality of image capture units each include a camera capturing an image data of one of surrounding parts of the vehicle a storage unit storing segment information for identifying each of segments divided from the image data captured by the camera, and importance degrees calculated for the segments based on resolutions which are required of the segments in the image data upon generation of the combined image data.

According to an embodiment, an image compressing unit is provided that compresses each of the segments of the image data at a compression ratio depending on a corresponding importance degree for each of the segments, and generates compressed image data and a transmitting unit transmits the compressed image data to the image processing apparatus through the network. The image processing apparatus includes a network interface unit inputting the compressed image data transmitted from each of the image capture units, an image generating unit generating a combined image data based on the compressed image data and a transmitting unit transmitting the combined image data to the display apparatus, and the display apparatus includes a receiving unit receiving the combined image data transmitted from the image processing apparatus; and a display unit displaying the combined image data.

Aspects and advantages of the invention will be realized and attained by means of the elements and combinations particularly pointed out in the claims. It is to be understood that both the foregoing general description and the following detailed description are exemplary and explanatory and are not restrictive of the invention, as claimed.

Additional aspects and/or advantages will be set forth in part in the description which follows and, in part, will be apparent from the description, or may be learned by practice of the invention.

### BRIEF DESCRIPTION OF THE DRAWINGS

FIG. 1 is a diagram illustrating a relationship between an image capture range and an image resolution;

FIG. 2 is a diagram illustrating a configuration of an image processing system;

FIG. 3 is a diagram illustrating configurations of first to fourth image capture units;

FIG. 4 is a diagram illustrating positions of cameras mounted on a vehicle;

FIG. 5 illustrates segment importance degree pattern data;

FIG. 6 illustrates a hardware configuration of a compression ratio control unit;

FIG. 7 is a diagram explaining a process by a compression ratio control unit and a process by an image compressing unit;

FIG. 8 is a diagram explaining a process by a compression ratio control unit and that by an image compressing unit;

FIG. 9 illustrates a hardware configuration of a control unit in an image processing apparatus;

FIGS. 10A and 10B each illustrate an image displayed on a display unit;

FIGS. 11A and 11B each illustrate an image displayed on the display unit;

FIGS. 12A and 12B each illustrates an image displayed on the display unit;

FIG. 13 is a flowchart showing a process of generating combined-image conversion pattern data and segment importance degree pattern data;

FIG. 14 is a flowchart illustrating a process of generating segment importance degree pattern data;

FIG. 15A is a diagram illustrating a system of coordinates of a vehicle viewed from above in a vertical direction (Z axis direction);

FIG. 15B is a diagram illustrating a system of coordinates of a vehicle viewed from a side in a widthwise direction (X axis direction);

FIG. 16 is a diagram explaining an attachment angle of a camera;

FIG. 17 is a diagram explaining combined-image layout pattern data;

FIGS. 18A and 18B are diagrams illustrating combined-image conversion pattern data;

FIGS. 19A and 19B are diagrams explaining examples of a correction range for an importance degrees distribution in image data;

FIGS. 20A, 20B, 20C and 20D are diagrams illustrating distributions of importance degrees in camera image data;

FIG. 21 illustrates segment importance degree pattern data generated for the first to fourth image capture units;

FIG. 22 is a flowchart showing a process by each image capture unit; and

FIG. 23 is a flowchart illustrating a process by the image processing apparatus.

### DESCRIPTION OF EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

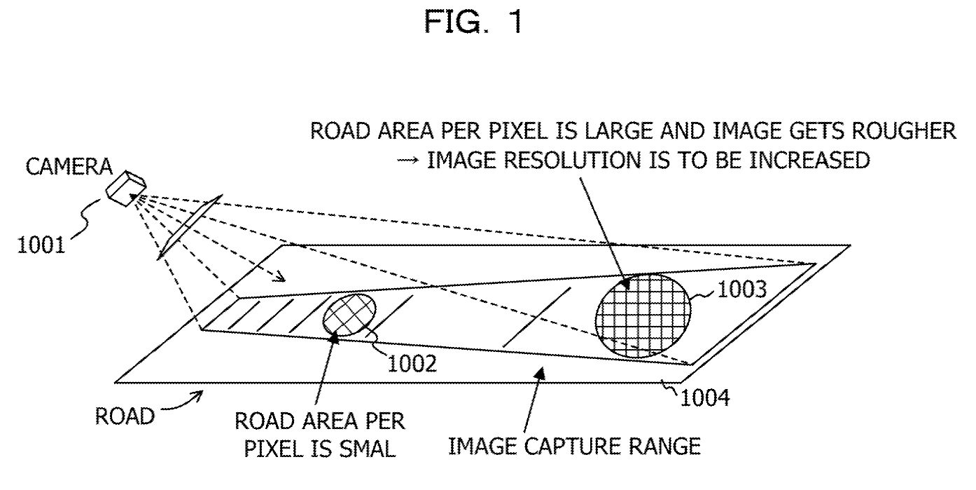

By switching a pattern of a combined image generated by an image processing apparatus to another one in accordance with a driver's driving operation, such as turning to right or left, changing lanes, or parking a car into a garage, convenience of the driver can be increased. A portion to be used in an image captured through each camera and the resolution of a necessary image differ depending on combined image pattern. For example, the road area per pixel of an image is small in a location 1002 close to a camera 1001, as shown in FIG. 1. As the location is further apart from the camera, as indicated by 1003, the road area per pixel of an image becomes larger. Therefore, for example, assuming that a bird's-eye view image is to be generated, a wide image has to be generated using fewer pixels as a target location is further apart from the camera in an image capture range 1004. Disadvantageously, the generated image is coarse.

Accordingly, in order to generate different types of combined images with high definition while reducing an amount of data transmitted from each image capture device, such as a camera, to the image processing apparatus, it is necessary to adjust the resolutions of segments, which are to be used in the combined images, in an image captured through each camera and transmit a resultant image from the camera to the image processing apparatus.

An embodiment will be described below with reference to the accompanying drawings.

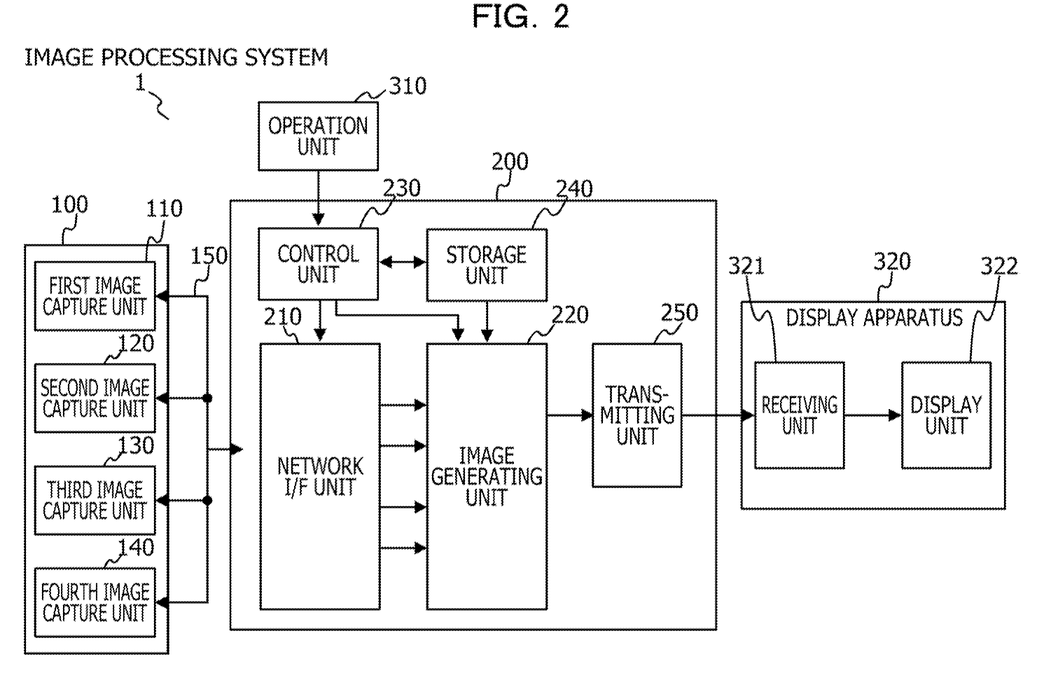

Referring to FIG. 2, an image processing system 1 according to an embodiment includes an image capture apparatus 100, an image processing apparatus 200, an operation unit 310, and a display apparatus 320. The image capture apparatus 100 includes a first image capture unit 110, a second image capture unit 120, a third image capture unit 130, and a fourth image capture unit 140. The image processing apparatus 200 includes a network interface (hereinafter, abbreviated to “I/F”) unit 210, an image generating unit 220, a control unit 230, a storage unit 240, and a transmitting unit 250. The display apparatus 320 includes a receiving unit 321 and a display unit 322. The image capture apparatus 100 and the image processing apparatus 200 are connected through a network 150, e.g., a LAN so that the apparatuses can communicate with each other.

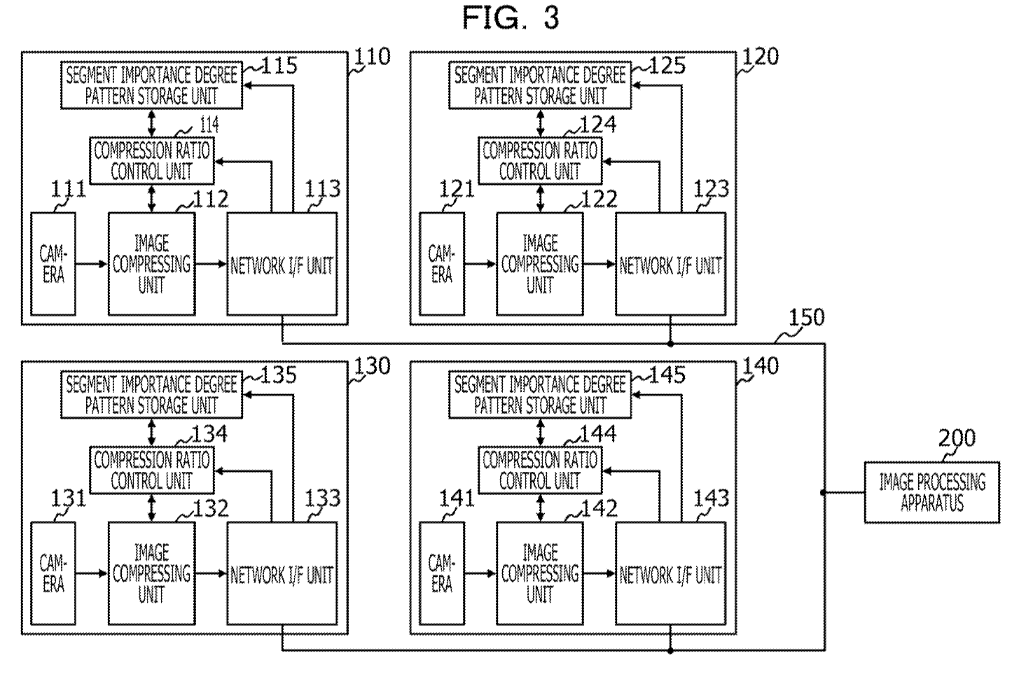

The image capture apparatus 100 will now be described in detail with reference to FIG. 3. Since the first to fourth image capture units 110, 120, 130 and 140 have substantially the same configuration, the first image capture unit 110 will be described below as a representative example. The first image capture unit 110 includes a camera 111, an image compressing unit 112, a network I/F unit 113, a compression ratio control unit 114, and a segment importance degree pattern storage unit 115.

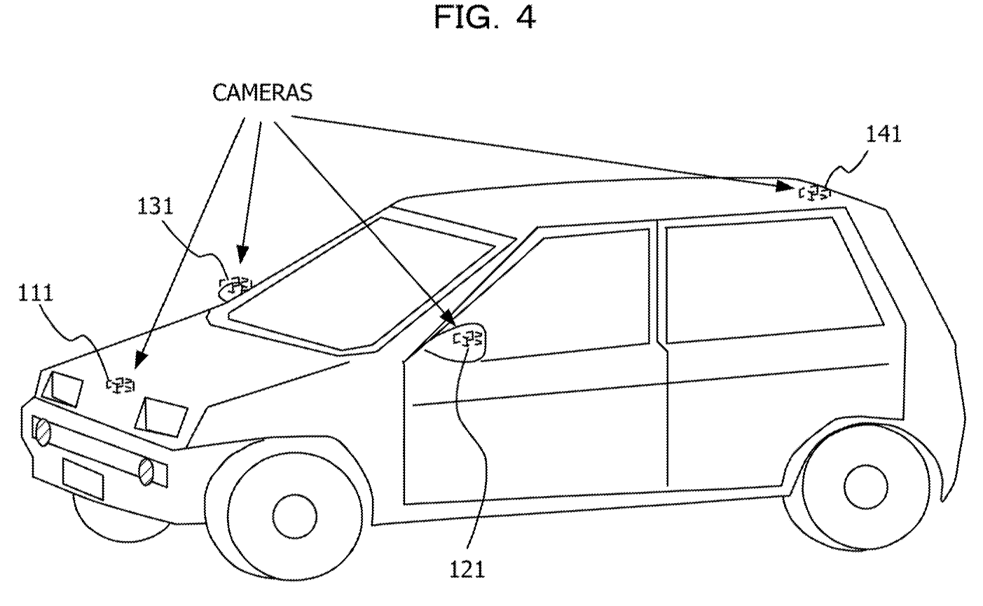

The camera 111 captures an image of surroundings of a vehicle and outputs captured image data to the image compressing unit 112. FIG. 4 illustrates attachment positions of the camera 111 of the first image capture unit 110, a camera 121 of the second image capture unit 120, a camera 131 of the third image capture unit 130, and a camera 141 of the fourth image capture unit 140 on the vehicle. The camera 111, which is placed on the front of the vehicle, captures an image of an area before the vehicle. The camera 121, placed on the left of the vehicle, captures an image of an area to the left of the vehicle. The camera 131, placed on the right of the vehicle, captures an image of an area to the right of the vehicle. The camera 141, placed on the rear of the vehicle, captures an image of an area behind the vehicle. Although the four cameras are mounted on the vehicle in an embodiment, a number of cameras is not limited to four. Three, five, or six cameras may be used. For example, when each camera includes a wide-angle lens, a number of cameras placed can be reduced. In addition, so long as the cameras can cooperate with each other in the image processing system, the cameras may be mounted on the vehicle before shipment, alternatively, the cameras may be mounted on the vehicle after shipment.

The image compressing unit 112 functions as an image compressing component that compresses image data captured through the camera 111 at a compression ratio specified through the compression ratio control unit 114. The image compressing unit 112 also functions as a transmitting component that outputs the compressed image data to the network I/F unit 113.

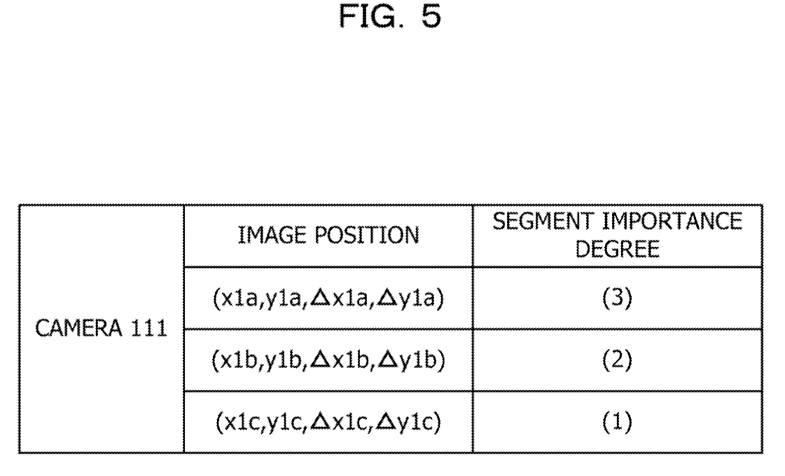

The segment importance degree pattern storage unit 115 is a storage component that stores segment importance degree pattern data indicating importance degrees of a plurality of segments divided from image data. FIG. 5 illustrates segment importance degree pattern data. Referring to FIG. 5, the segment importance degree pattern data includes image positions and segment importance degrees. Information stored as an image position represents position coordinates indicating a position of a segment divided from image data. Information stored as a segment importance degree represents the importance degree of an image data segment in the corresponding position coordinates. As for examples of the position coordinates, for example, the upper left coordinates of each segment and the lower right coordinates thereof can be used. The importance degree is information that reflects a resolution of the corresponding image data segment, the resolution being required upon generating a combined image. The details of the importance degrees is described in detail below.

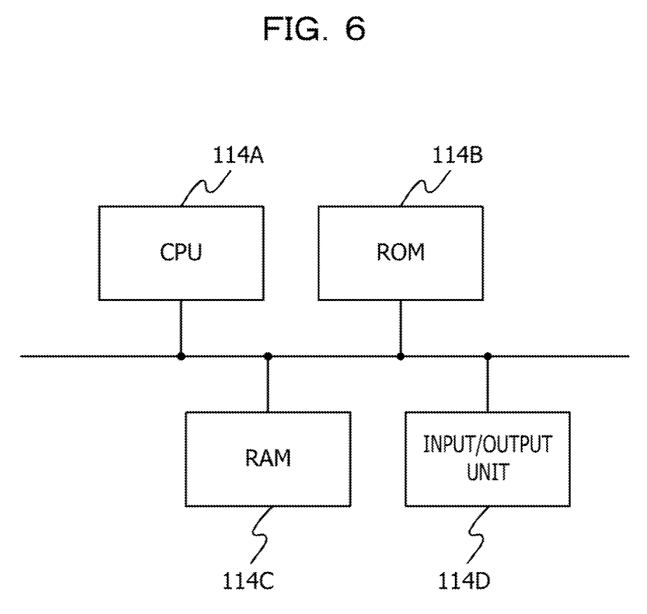

Referring to FIG. 6, the compression ratio control unit 114 includes hardware such as a central processing unit (CPU) 114A, a read-only memory (ROM) 114B, a random access memory (RAM) 114C, and an input/output unit 114D. The CPU 114A operates in accordance with a program stored in the ROM 114B. The RAM 114C sores data including data which the CPU 114A uses for calculation. The input-output unit 140 receives an instruction signal or the like transmitted from the control unit 230 of the image processing apparatus 200. In addition, the input-output unit 140 outputs a compression ratio control signal supplied from the CPU 114A to the image compressing unit 112. RAM114C is one of the examples of the segment importance degree pattern storage unit 115.

The compression ratio control unit 114 accepts an instruction specifying a generation pattern for combined image data from the control unit 230 of the image processing apparatus 200 through the network I/F unit 113. In response to the instruction from the control unit 230, the compression ratio control unit 114 reads segment importance degree pattern data relevant to the specified generation pattern from the segment importance degree pattern storage unit 115. The compression ratio control unit 114 controls compression ratios in image data captured through the camera 111 in accordance with the read segment importance degree pattern data. Note that combined image data is image data generated by processing, for example, performing coordinate transformation on camera image data captured through the cameras 111, 121, 131, and 141. Segments to be used in camera image data or coordinate transformation may be changed, so that a plurality of types, namely, different patterns of combined image data are generated. The details of combined image data are described in detail below.

A process by the compression ratio control unit 114 will now be concretely described.

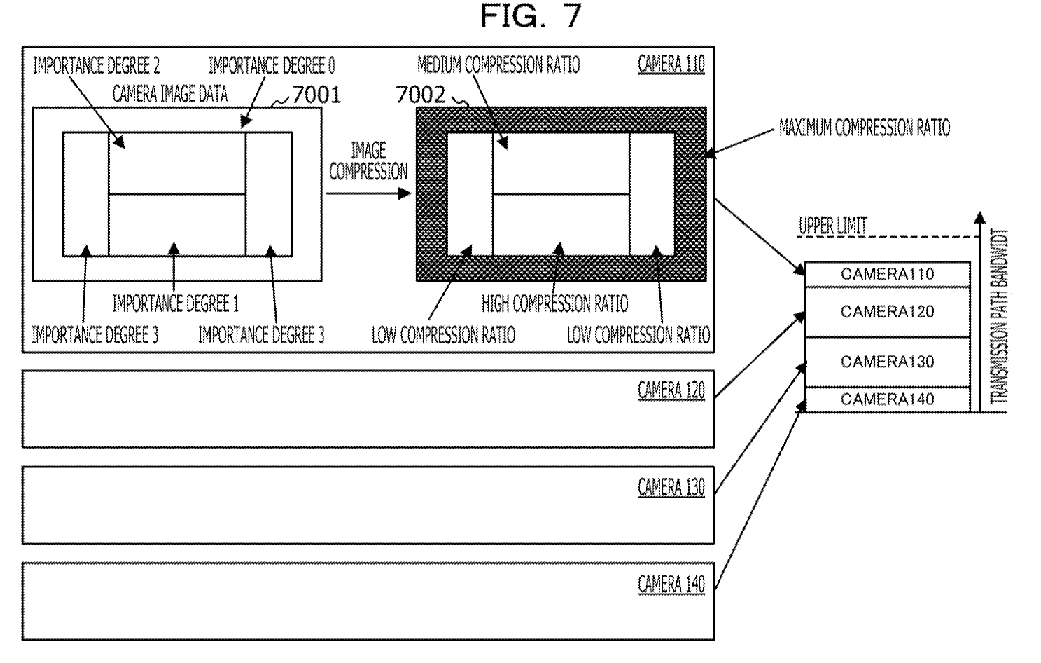

It is assumed that the importance degrees of segments of image data are determined on the basis of segment importance degree pattern data, for example, as shown in part 7001 of FIG. 7. In part 7001, a segment assigned the importance degree 1 is an image data segment assigned a low importance degree. A segment assigned the importance degree 2 is an image data segment assigned a medium importance degree. A segment assigned the importance degree 3 is an image data segment assigned a high importance degree. A segment assigned the importance degree 0 is an image data segment that is not important, namely, an image data that is not to be included in combined image data. As for segment importance degree pattern data stored in each of the segment importance degree pattern storage units 115, 125, 135, and 145, it is unnecessary to include the position coordinates of an image data segment assigned the importance degree 0 in the pattern data. In other words, so long as the position coordinates of image data segments assigned the importance degrees 1, 2 and 3 are determined, all of other image data segments can be determined as image data segments assigned the importance degree 0.

The compression ratio control unit 114 controls an amount of compression codes allocated to an image data segment assigned the high importance degree, i.e., the importance degree 3, as shown in part 7002 of FIG. 7, so as to reduce the compression ratio of this image data segment. On the other hand, the compression ratio control unit 114 controls the amount of compression codes allocated to an image data segment assigned the low importance degree, i.e., the importance degree 1 so as to increase the compression ratio of this image data segment. Specifically, the compression ratio control unit 114 controls the amounts of compression codes so that the compression ratio of a segment assigned the high importance degree is set to a low value and the compression ratio of a segment assigned the low importance degree is higher than that of the segment assigned the high importance degree. Camera image data captured through the cameras 111 to 141 are compressed and are then transmitted to the image processing apparatus 200, so that the amount of data transmitted over the network 150 can be reduced, as shown in FIG. 7.

The process by the compression ratio control unit 114 will now be more concretely described. First, description will be given with respect to a transmission data amount management unit, a compression data amount management unit, and a compression unit which will be used in the following description.

The transmission data amount management unit is a management unit for adjusting the amount of data packets to be transmitted over a transmission path. For example, the transmission data amount management unit is set in units of frames, e.g., one frame or eight frames. In a method for transmission in which the compression ratio per transmission data amount management unit is fixed, the amount of compression codes available per frame, serving as the transmission data amount management unit, is fixed to a constant value.

The compression data amount management unit is a management unit for adjusting the amount of compression codes. For example, when the compression ratio is fixed, the amount of compression codes to be generated is adjusted to a constant value on the basis of the compression data amount management unit. The compression data amount management unit is set in units of, for example, lines (image lines) constituting image data, e.g., eight lines.

The compression unit is a unit for allocating compression codes. On the side in which packets are received, data is decompressed in this compression unit.

In the following description, it is assumed that the transmission data amount management unit is set to, for example, one frame. A method for transmission in which the compression ratio per transmission data amount management unit is fixed will now be described.

In the case where the compression ratio per frame is fixed, the compression ratio control unit 114 determines the amount of codes to be allocated in each compression data amount management unit. In the following description, it is assumed that the compression data amount management unit is set to, for example, eight lines.

First, the compression ratio control unit 114 allocates compression codes to unnecessary pixels, corresponding to a segment assigned the importance degree 0, of pixels included in one frame so that the compression ratio is set to a maximum value, namely, the amount of compression codes is set to a minimum value.

Subsequently, the compression ratio control unit 114 subtracts the amount of compression codes allocated to the unnecessary pixels from the amount of compression codes that can be allocated in the transmission data amount management unit to obtain the amount of remaining compression codes. After that, the compression ratio control unit 114 allocates the obtained remaining compression codes to pixels in accordance with the proportion of the sums of pixels classified by segment importance degree in the compression data amount management unit. Specifically, the sum of pixels is obtained with respect to each of the importance degrees 1, 2 and 3 and the amount of remaining codes is divided in accordance with the obtained sums of pixels classified by importance degree and the proportion of the importance degrees (1, 2 and 3), thus determining the amount of compression codes allocated to each pixel.

The amount of codes allocated to each pixel can also be determined on the basis of the degree of complexity of image content and the importance degree of the corresponding image data segment. For example, the compression ratio control unit 114 first obtains the degree of complexity in each compression data amount management unit. For instance, the degree of complexity of image data can be determined on the basis of the amount of high-frequency components included in the image data. For example, it is assumed that the degree of complexity of image data is determined on a scale of 1 to 5. The compression ratio control unit 114 corrects the determined degree of complexity in accordance with the importance degree of each image data segment to determine the amount of compression codes allocated to each of the corresponding pixels. For instance, even when the degree of complexity of an image data segment is indicated at “5” corresponding to “high complexity”, so long as the importance degree of the image data segment is low, an evaluation value indicating the degree of complexity is corrected to a low value. On the other hand, if the degree of complexity of an image data segment is indicated at “1” corresponding to “low complexity”, so long as the importance degree thereof is high, an evaluation value indicating the degree of complexity is corrected to a high value. The compression ratio control unit 114 determines the amount of codes allocated to each pixel on the basis of an evaluation value representing the corrected degree of complexity.

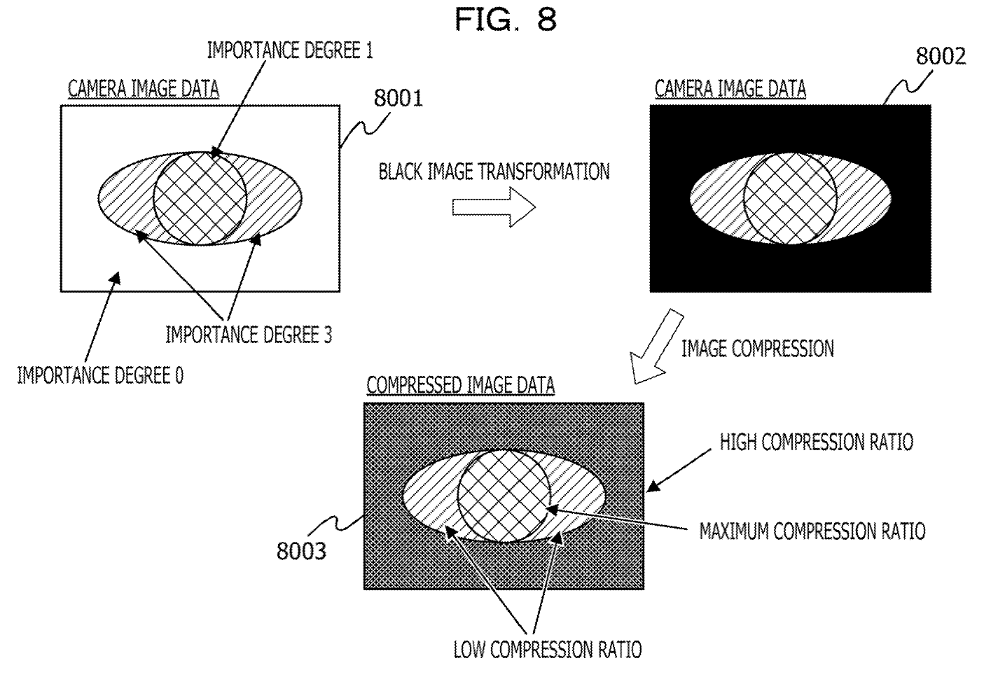

Before compression of image data, an image data segment assigned the importance degree 0 may be previously replaced with, for example, a black image segment indicated by a fixed value, as shown in parts 8001 and 8002 in FIG. 8. When the image data segment assigned the importance degree 0 is replaced with such a black image segment indicated by the fixed value, the replaced image data segment is processed at a high compression ratio, as shown in part 8003 in FIG. 8, in accordance with the determined degree of complexity.

The network I/F unit 113 includes a buffer (not shown). The network I/F unit 113 temporarily stores image data, compressed and output by the image compressing unit 112, into the buffer. The network I/F unit 113 divides the stored image data into data packets and transmits the data packets through the network 150 to the image processing apparatus 200 while controlling a transmission rate. The network I/F unit 113 operate as a transmitting unit. Note that the number of packets output from the network I/F unit 113 to the network 150 is determined to a predetermined value within a fixed period of time. Accordingly, as the size of image data is reduced by compression through the image compressing unit 112, the size of each data packet is also reduced in accordance with the reduction. The data packets generated by the network I/F unit 113 are transmitted through the network 150 to the image processing apparatus 200.

The image processing apparatus 200 in FIG. 2 will now be described.

The network I/F unit 210 is an input unit that receives data packets transmitted from the first to fourth image capture units 110, 120, 130 and 140. The network I/F unit 210 also includes a buffer (not illustrated) and temporarily stores the received data packets into the buffer. The network I/F unit 210 decompresses the received packet data into image data and adds blanking data to the image data and then outputs the resultant data to the image generating unit 220. When receiving the data packets from the first to fourth image capture units 110, 120, 130 and 140, the network I/F unit 210 may output the received data packets as data sequences to the image generating unit 220 without decompressing the packet data into image data. In this case, the image generating unit 220 converts the data sequences into image data.

Each image data segment assigned the importance degree 0 to which compression codes are allocated to provide a high compression ratio in the image capture apparatus 100 is received as specific color data or specific pattern data by the image processing apparatus 200. Since this segment is not used for generation of combined image data, the segment does not affect the combined image data.

The image generating unit 220 coordinate-transforms image data respectively transmitted from the first to fourth image capture units 110, 120, 130 and 140 to generate combined image data. The storage unit 240 stores combined-image conversion pattern data, which is described in detail below. The image generating unit 220 acquires combined-image conversion pattern data for generating combined image data, specified through the control unit 230, from the storage unit 240. The image generating unit 220 coordinate-transforms the image data respectively transmitted from the first to fourth image capture units 110, 120, 130 and 140 in accordance with the acquired combined-image conversion pattern data to generate combined image data.

The transmitting unit 250 transmits the combined image data generated by the image generating unit 220 to the display apparatus 320.

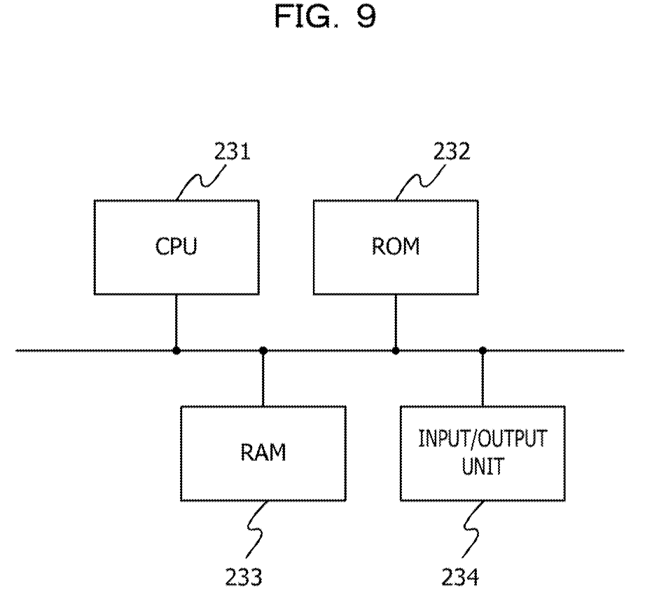

The control unit 230 will now be described. FIG. 9 illustrates the hardware configuration of the control unit 230. The control unit 230 includes a CPU 231, a ROM 232, a RAM 233, and an input-output unit 234 as hardware.

The ROM 232 stores a program that the CPU 231 uses for control. The CPU 231 reads the program stored in the ROM 232 and performs a process in accordance with the read program. The RAM 233 stores data that the CPU 231 uses for calculation and data indicating results of calculation. The input-output unit 234 accepts an operation input entered through the operation unit 310 by a user and outputs the input to the CPU 231. In addition, the input-output unit 234 outputs an instruction signal output from the CPU 231 to the network I/F unit 210. The network I/F unit 210 transmits the instruction signal output from the input-output unit 234 through the network 150 to the first to fourth image capture units 110, 120, 130 and 140. RAM233 is one of the examples of the storage unit 240.

The control unit 230 generates a plurality of segment importance degree pattern data for each pattern of combined image data. The segment importance degree pattern data are generated for each of the first to fourth image capture units 110, 120, 130 and 140. The control unit 230 transmits the generated segment importance degree pattern data through the network 150 to the image capture apparatus 100. The first, second, third, and fourth image capture units 110, 120, 130, and 140 store the relevant segment importance degree pattern data, transmitted from the control unit 230, into the segment importance degree pattern storage units 115, 125, 135, and 145, respectively. For example, the first image capture unit 110 stores the segment importance degree pattern data into the segment importance degree pattern storage unit 115. As for the segment importance degree pattern data, all of data for patterns of combined image data may be stored in each segment importance degree pattern storage unit. Alternatively, when a pattern of combined image data is switched to another one, the relevant segment importance degree pattern data may be transmitted and stored into each segment importance degree pattern storage unit.

In addition, the control unit 230 generates combined-image conversion pattern data, which is described in detail below, and stores the generated data into the storage unit 240. A plurality of combined-image conversion pattern data are generated for each pattern of combined image data.

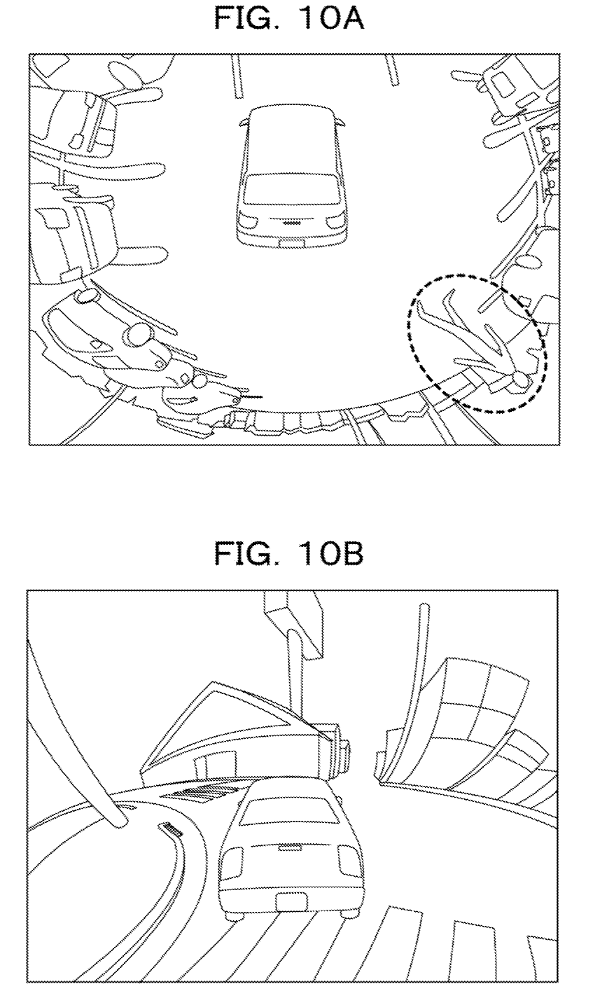

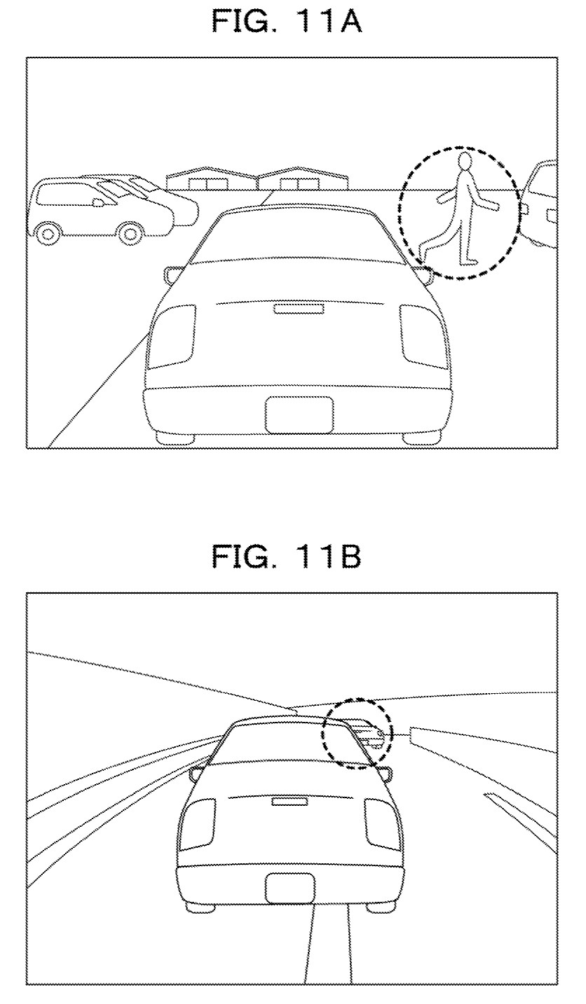

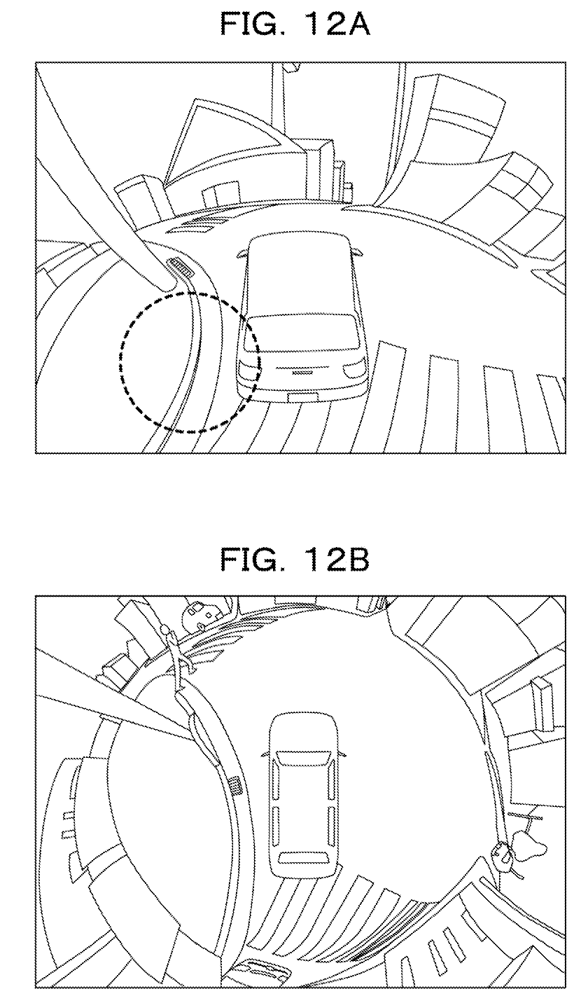

The operation unit 310 accepts an operation input from the user. The display apparatus 320 includes the receiving unit 321 that receives combined image data transmitted from the image processing apparatus 200 and the display unit 322 that displays the received combined image data. The transmitting unit 250 transmits combined image data, generated by the image processing apparatus 200, to the display apparatus 320. The display apparatus 320 receives the combined image data, transmitted from the transmitting unit 250, through the receiving unit 321 and displays the data on the display unit 322. The operator operates the operation unit 310 to switch between different patterns of combined image displayed on the display unit 322. Examples (patterns) of combined image displayed on the display unit 322 are shown in FIGS. 10A, 10B, 11A, 11B, 12A, and 12B. The combined image patterns are not limited to these examples. A single type of pattern may be used. Alternatively, different types of patterns may be used.

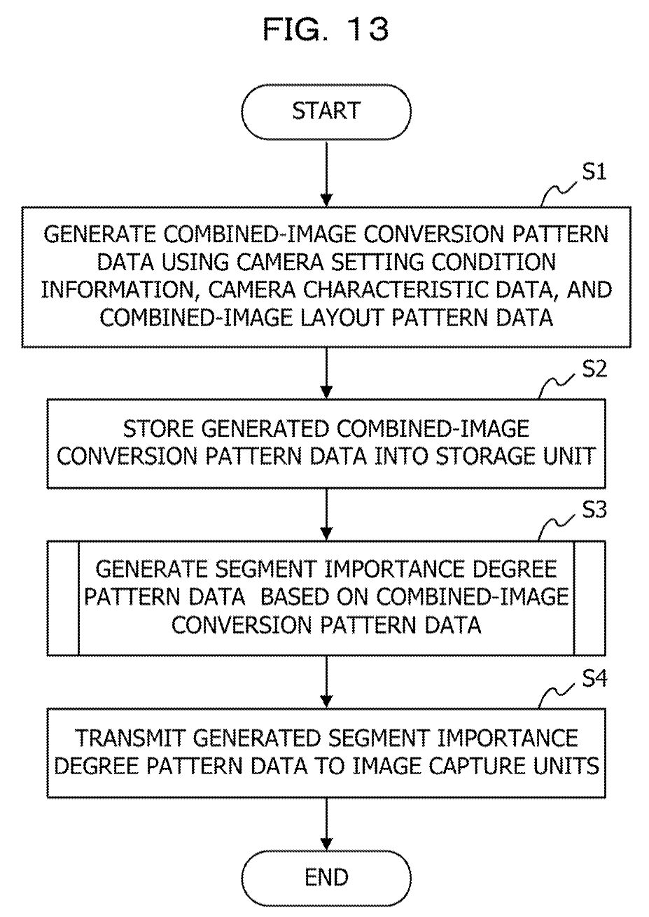

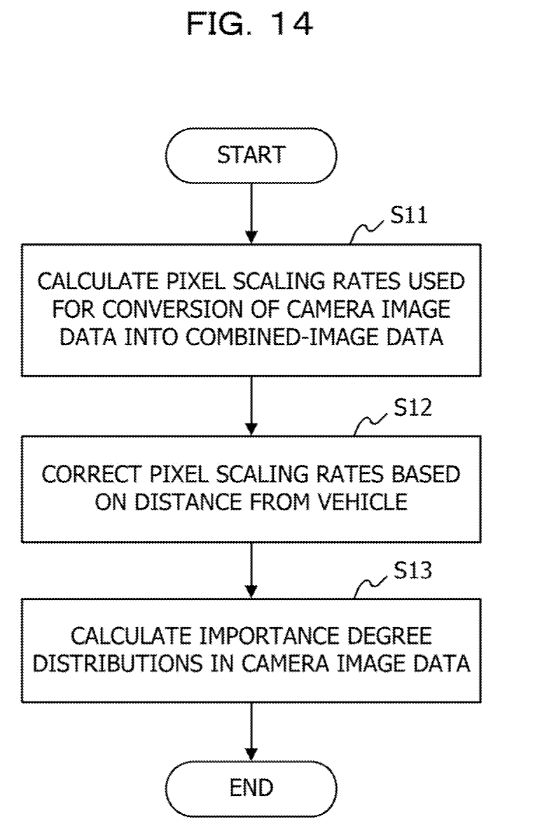

A process for generating segment importance degree pattern data through the control unit 230 and a process for generating combined-image conversion pattern data through the control unit 230 will now be described with reference to flowcharts of FIGS. 13 and 14.

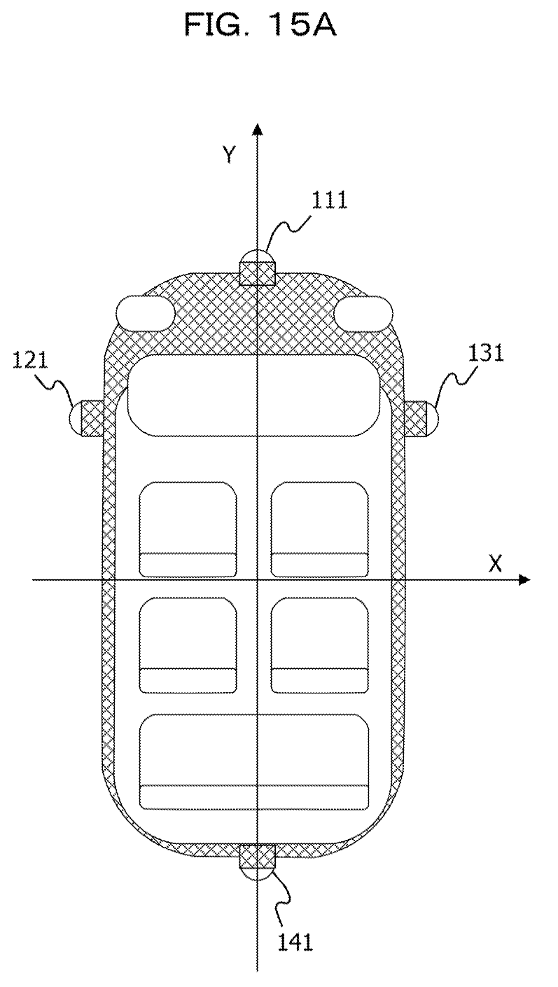

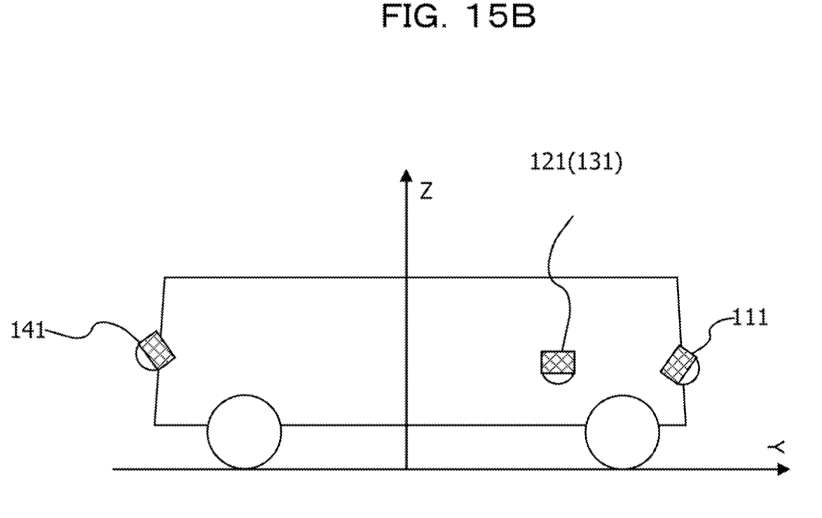

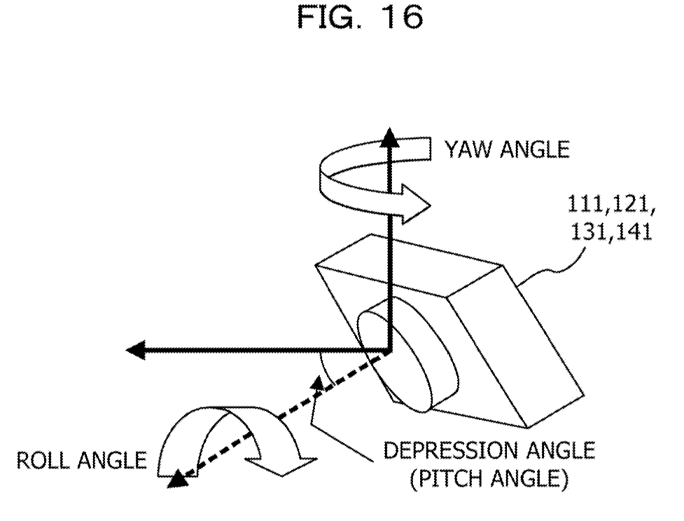

As preparation, position coordinates and attachment angles of the cameras 111, 121, 131, and 141 mounted on the vehicle are previously calculated. Such calculation may use one or more techniques. A worker calculates the position coordinates and the attachment angles of the cameras using equipment. It is assumed that the center of the vehicle is set to the origin, the widthwise direction of the vehicle is set to the X axis, the lengthwise direction thereof is set to the Y axis, and the vertical direction thereof is set to the Z axis, as illustrated in FIGS. 15A and 15B. FIG. 15A illustrates the system of coordinates of the vehicle viewed from above in the vertical direction (along the Z axis). FIG. 15B illustrates the system of coordinates of the vehicle viewed from the side in the widthwise direction (along the X axis). The attachment angle of each camera may include a yaw angle, an angle of depression (pitch angle), and a roll angle. The yaw angle is the angle of rotation about the vertical axis, as shown in FIG. 16. The roll angle is the angle of rotation about the optical axis of the camera. The pitch angle is the angle of inclination of the camera in the longitudinal direction. In the following description, the position coordinates and the attachment angle of each camera will be generally called camera setting condition information. Camera setting condition information is input through the operation unit 310 and is stored into the storage unit 240 under the control of the control unit 230.

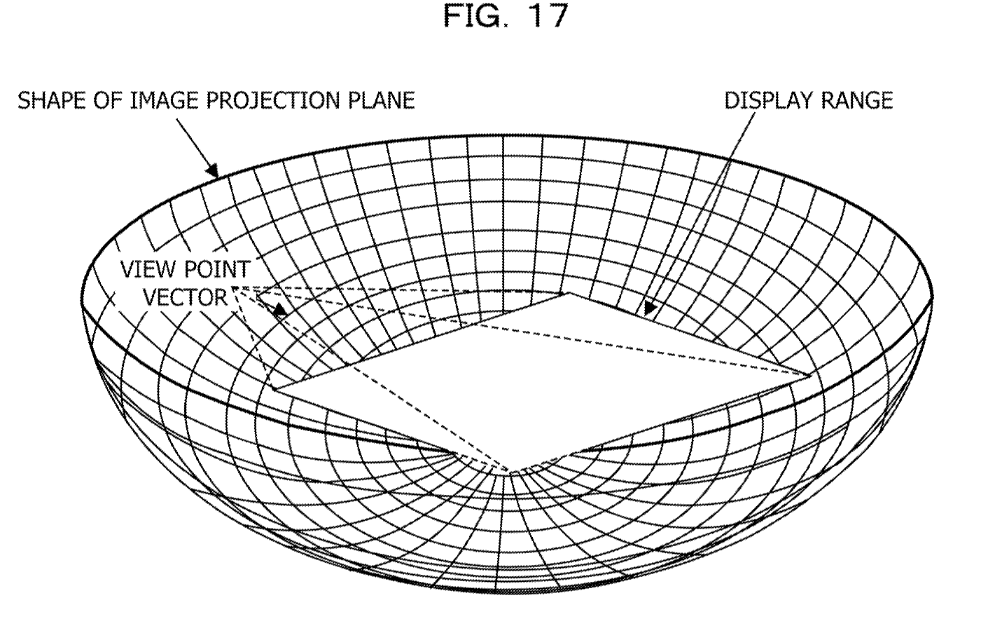

Data previously stored in the storage unit 240 includes characteristic data of the cameras 111, 121, 131, and 141 and combined-image layout pattern data in addition to the camera setting condition information. The characteristic data includes the number of pixels in the horizontal direction and that in the vertical direction of each of the cameras 111, 121, 131, and 141, the angle of view thereof, and lens distortion data thereof. The angle of view of each of the cameras 111, 121, 131, and 141 is the viewing angle thereof. The lens distortion data is data about lens distortion aberration. The combined-image layout pattern data includes image projection plane shape data, view point vector data, image display range data, and the like. The image projection plane shape data is data about the form of a projection plane where a plurality of image data are projected, as shown in FIG. 17, in order to generate combined image data based on the camera image data captured through the cameras 111, 121, 131, and 141. The view point vector data is data to determine the position of a view point relative to the display range of a combined image in the image projection plane where the image data are projected. A scaling rate for each of parts of the images captured through the cameras 111 to 141 varies on the basis of the image projection plane shape data and the view point vector data. The image display range data is data indicating the display range of a combined image, as shown in FIG. 17.

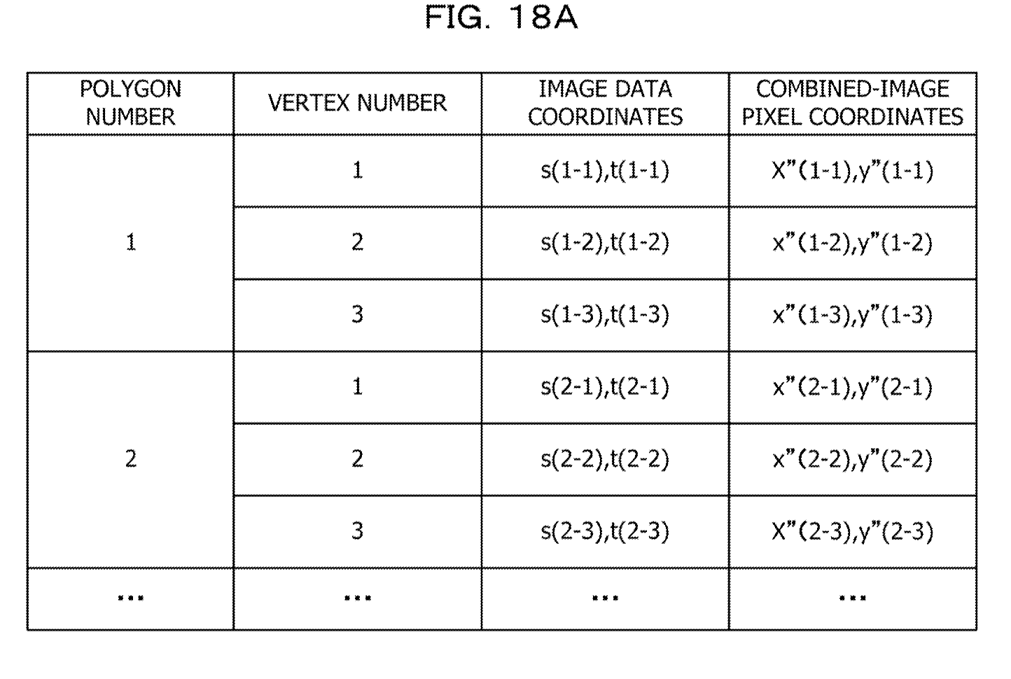

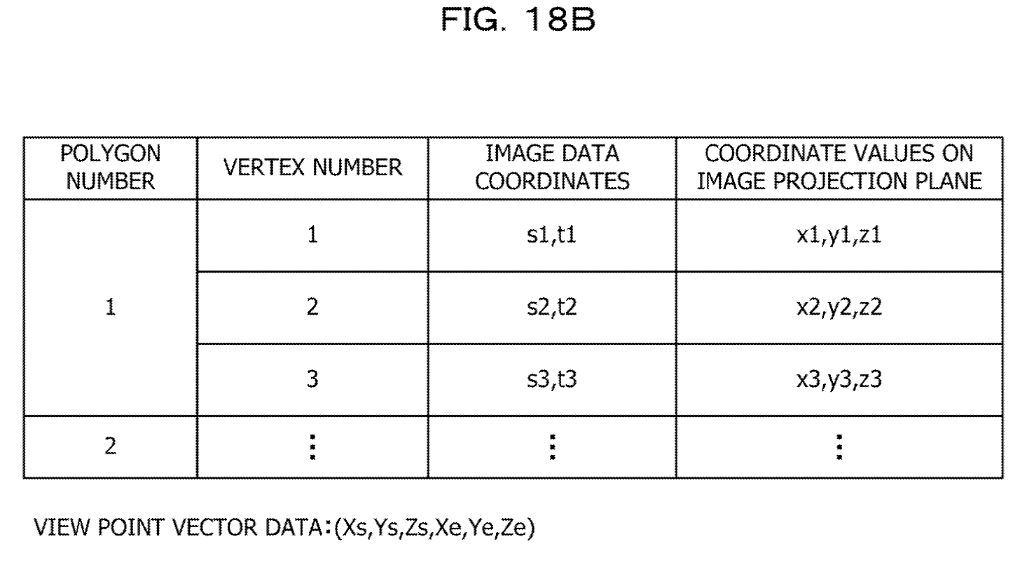

The control unit 230, for example, generates combined-image conversion pattern data using the camera setting condition information, the camera characteristic data, and the combined-image layout pattern data stored in the storage unit 240 (operation S1). The combined-image conversion pattern data is coordinate transformation data to converts camera image data captured through the cameras 111, 121, 131, and 141 into combined image data. The combined-image conversion pattern data includes, for example, polygon numbers, vertex numbers each representing the number of a vertex of a polygon indicated by a polygon number, image data coordinates, and combined-image pixel coordinates. Image data coordinates are information indicating the coordinate values of each vertex indicated by the corresponding vertex number before coordinate transformation. Combined-image pixel coordinates are data indicating the coordinate values of each vertex indicated by the corresponding vertex number in combined-image data after coordinate transformation. Note that a polygon is a block which serves as a coordinate transformation unit used when image data captured through the cameras are coordinate-transformed into combined image data and the polygon numbers are identification numbers to identify the polygons. The combined-image conversion pattern data may have a data format shown in FIG. 18B. Referring to FIG. 18B, the combined-image conversion pattern data includes polygon numbers, vertex numbers of the polygons indicated by the polygon numbers, data indicating the coordinate values of each vertex indicated by the corresponding vertex number in image data before coordinate transformation, data indicating the coordinate values on an image projection plane, and view point vector data. The control unit 230 stores the generated combined-image conversion pattern data into the storage unit 240 (operation S2).

Subsequently, the control unit 230 generates a plurality of segment importance degree pattern data based on the combined-image conversion pattern data (operation S3). The process for generating the segment importance degree pattern data on the basis of the combined-image conversion pattern data will be described with reference to the flowchart of FIG. 14.

The control unit 230 then transmits the generated segment importance degree pattern data to the first to fourth image capture units 110, 120, 130 and 140 which serve as relevant image capture units (operation S4). The first, second, third, and fourth image capture units 110, 120, 130, and 140 store the segment importance degree pattern data transmitted from the control unit 230 into the segment importance degree pattern storage units 115, 125, 135, and 145, respectively. For example, the first image capture unit 110 stores the segment importance degree pattern data into the segment importance degree pattern storage unit 115.

The process for generating the segment importance degree pattern data on the basis of the combined-image conversion pattern data through the control unit 230 in operation S3 of FIG. 13 will now be described with reference to the flowchart of FIG. 14.

First, the control unit 230 calculates an available portion used for combined image data in each of the image data captured through the cameras 111, 121, 131, and 141 with reference to the combined-image conversion pattern data. In addition, the control unit 230 calculates a scaling rate based on the coordinate transformation of each pixel included in image data corresponding to each available portion (operation S11). Note that the scaling rate includes reduction. In the following description, the scaling rate will be termed “pixel scaling rate”. Furthermore, the control unit 230 calculates a distribution of pixel scaling rates on the basis of the calculated pixel scaling rates of the pixels. The control unit 230 calculates a pixel scaling rate at which each pixel of image data corresponding to each available portion is enlarged or reduced in accordance with the coordinate transformation. As for calculation of the pixel scaling rates, each pixel scaling rate in the X axis direction and that in the Y axis direction may be obtained. Alternatively, each pixel scaling rate may be obtained on the basis of the ratio of the area of the corresponding pixel before coordinate transformation to that after coordinate transformation.

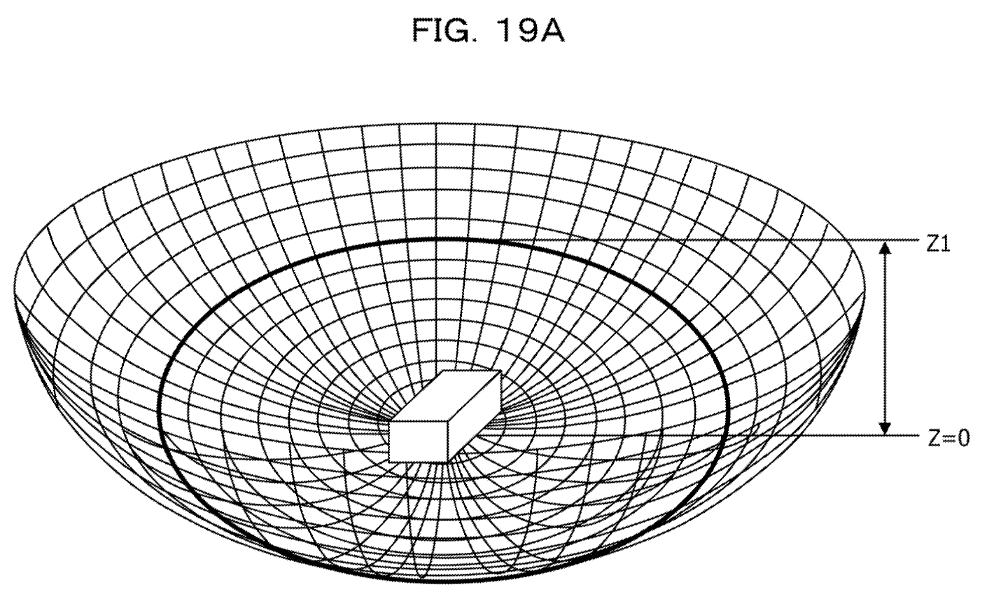

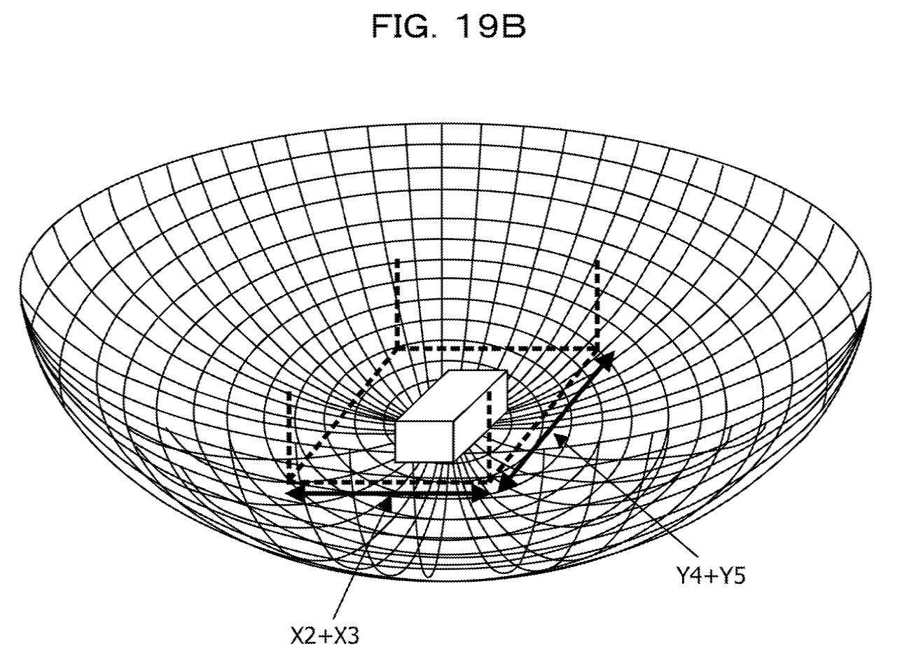

Subsequently, the control unit 230 obtains an area where the pixel scaling rates are corrected on the basis of the distance between the vehicle and a position corresponding to each pixel in image data to correct the pixel scaling rates (operation S12). For example, the control unit 230 determines a portion corresponding to a distant place or the sky which does not affect driving assistance in image data as a portion that is not needed in combined image data for driving assistance. The control unit 230 sets image data corresponding to such a portion to non-target data or data assigned the importance degree to be reduced. Referring to FIG. 19A, a rectangle at the center of coordinates represents the vehicle equipped with the image processing system 1. The control unit 230 corrects a pixel scaling rate of each pixel, whose coordinate value in the Z axis direction (vertical direction) is greater than a fixed value Z1, in combined image data to a predetermined value. Alternatively, the control unit 230 reduces the pixel scaling rate of such a pixel by a predetermined value. Referring to FIG. 19B, a predetermined area in the vicinity of the vehicle in the X axis direction and the Y axis direction is determined as an important area for driving assistance. For example, the control unit 230 obtains an area by adding a predetermined value to the width, indicated by X2, of the vehicle and adding a predetermined value to the length thereof, indicated by Y4, namely, an area specified by X2+X3 in the X axis direction and Y4+Y5 in the Y axis direction, and corrects a pixel scaling rate of each pixel located outside the area to a predetermined value. Alternatively, the control unit 230 reduces the pixel scaling rate of such a pixel by a predetermined value.

Then, the control unit 230 performs processing such as clustering or normalization on the pixel scaling rates of the pixels corrected in operation S12, thus clustering the pixel scaling rates. The control unit 230 obtains the distribution of importance degrees on the basis of the clustered pixel scaling rates (operation S13). For example, the control unit 230 obtains a cluster of pixels having pixel scaling rates of 5 or higher in image data, a cluster of pixels having pixel scaling rates ranging from 2 to less than 5, a cluster of pixels having pixel scaling rates ranging from greater than 0 to less than 2, and a cluster of pixels having a pixel scaling rate of 0. The control unit 230 sets the cluster of pixels having pixel scaling rates of 5 or higher to a pixel group assigned the high importance degree. In addition, the control unit 230 sets the cluster of pixels having pixel scaling rates ranging from 2 to less than 5 to a pixel group assigned the medium importance degree. Similarly, the control unit 230 sets the cluster of pixels having pixel scaling rates ranging from greater than 0 to less than 2 to a pixel group assigned the low importance degree. In addition, the control unit 230 sets the cluster of pixels having a pixel scaling rate of 0 to a pixel group assigned an importance degree of 0 (namely, a pixel group that is not used in combined image). Since the display area of each pixel having a high pixel scaling factor is large after conversion into combined image data, the pixel can be determined as data assigned the high importance degree. Since the display area of each pixel having a low pixel scaling factor is small after conversion into combined image data, the pixel can be determined as data assigned the low importance degree.

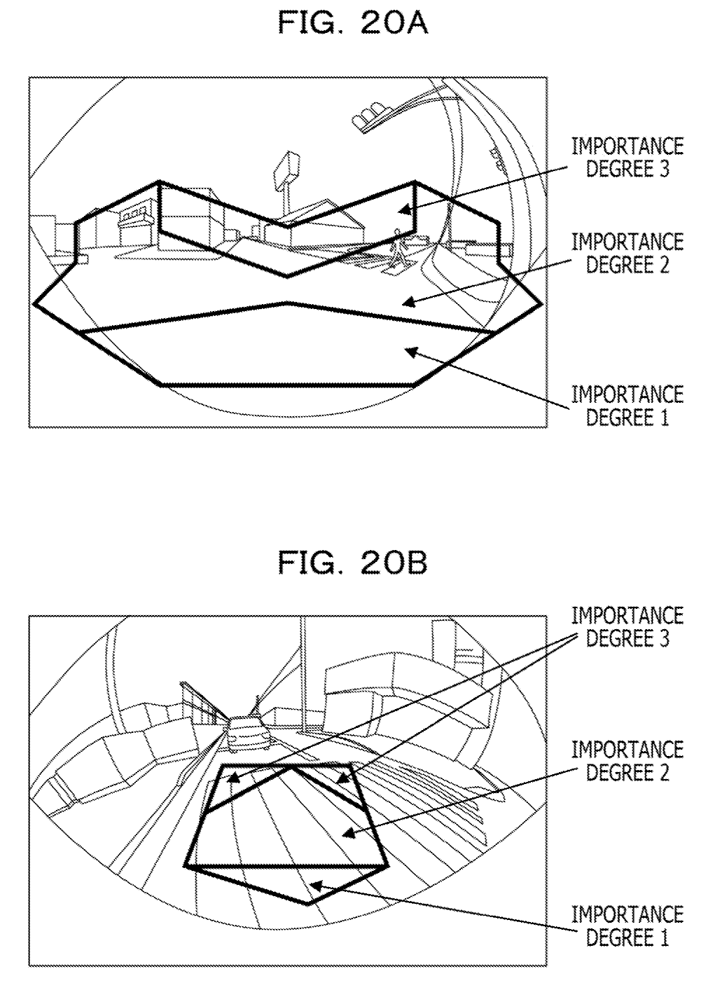

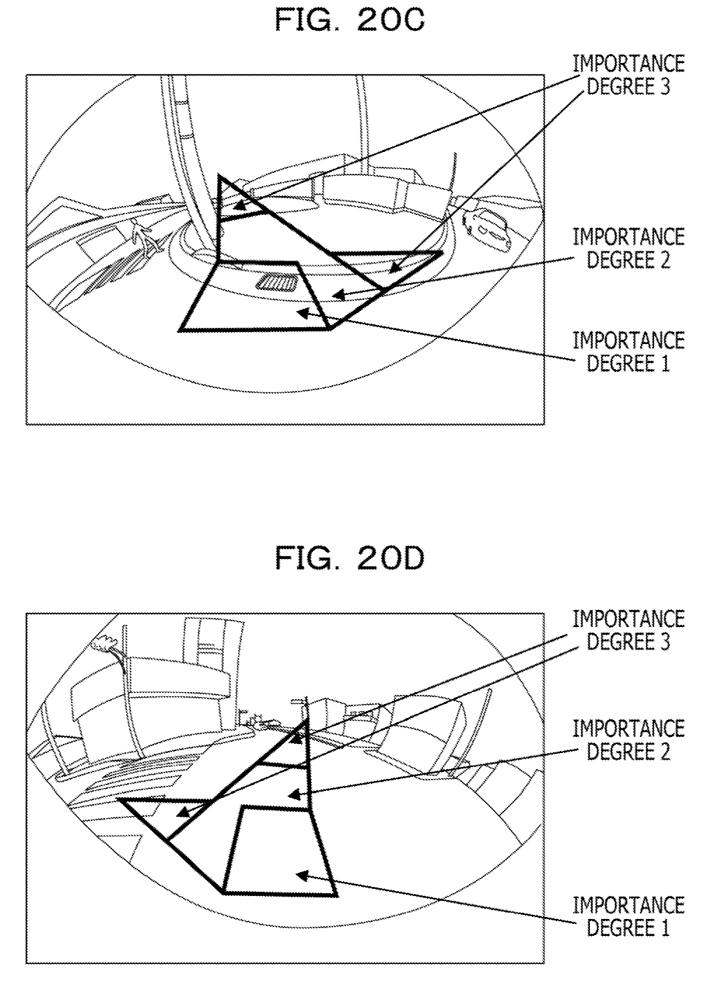

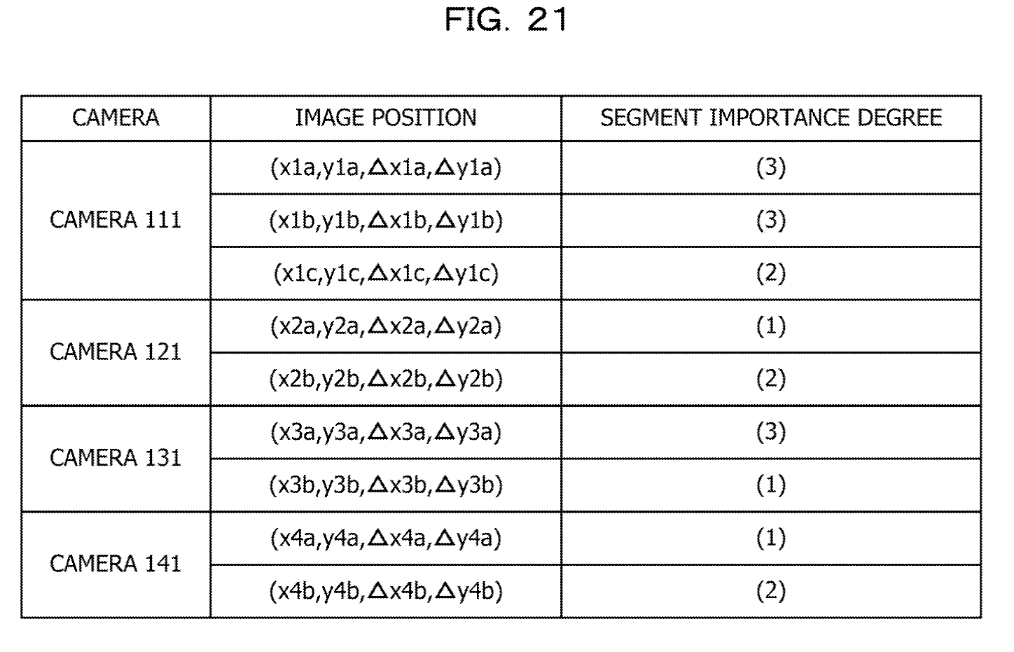

FIG. 20A illustrates the distribution of importance degrees in image data, representing a view in front of the vehicle, captured through the camera 111. FIG. 20B illustrates the distribution of importance degrees in image data, representing a view to the left of the vehicle, captured through the camera 121. FIG. 20C illustrates the distribution of importance degrees in image data, representing a view to the right of the vehicle, captured through the camera 131. FIG. 20D illustrates the distribution of importance degrees in image data, representing a view behind the vehicle, captured through the camera 141. FIG. 21 illustrates generated segment importance degree pattern data for the first to fourth image capture units 110, 120, 130 and 140.

The control unit 230 performs the above-described processes to generate segment importance degree pattern data and combined-image conversion pattern data. The control unit 230 transmits the segment importance degree pattern data, respectively generated for the camera image data captured though the cameras, to the first to fourth image capture units 110, 120, 130 and 140. The segment importance degree pattern storage units 115, 125, 135, and 145 of the first, second, third, and fourth image capture units 110, 120, 130, and 140 each store an importance degree pattern data for each pattern of combined image data.

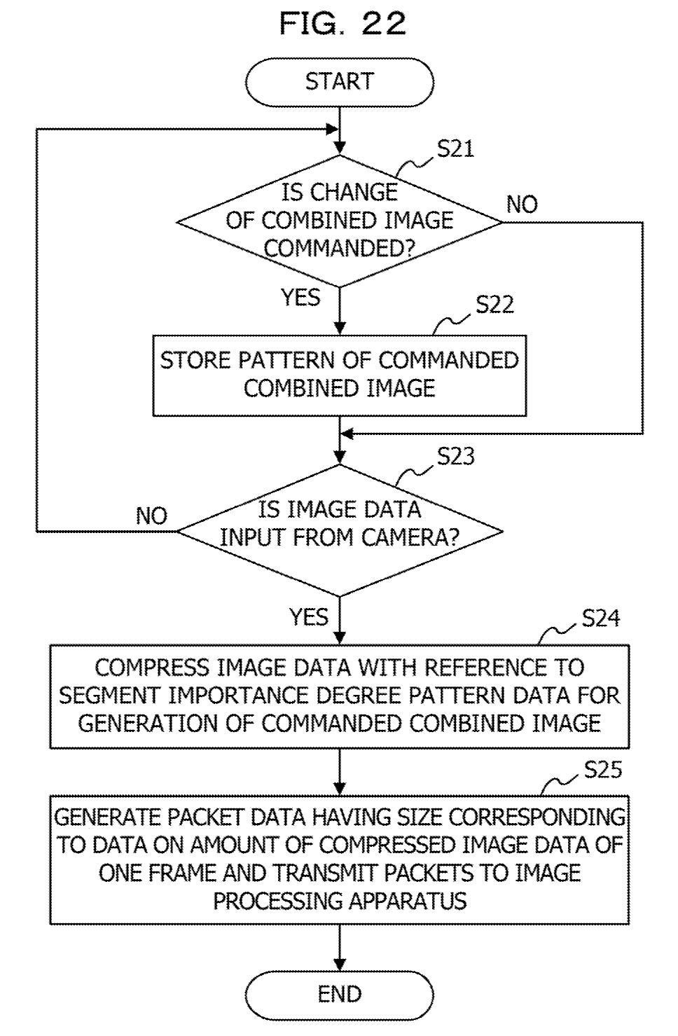

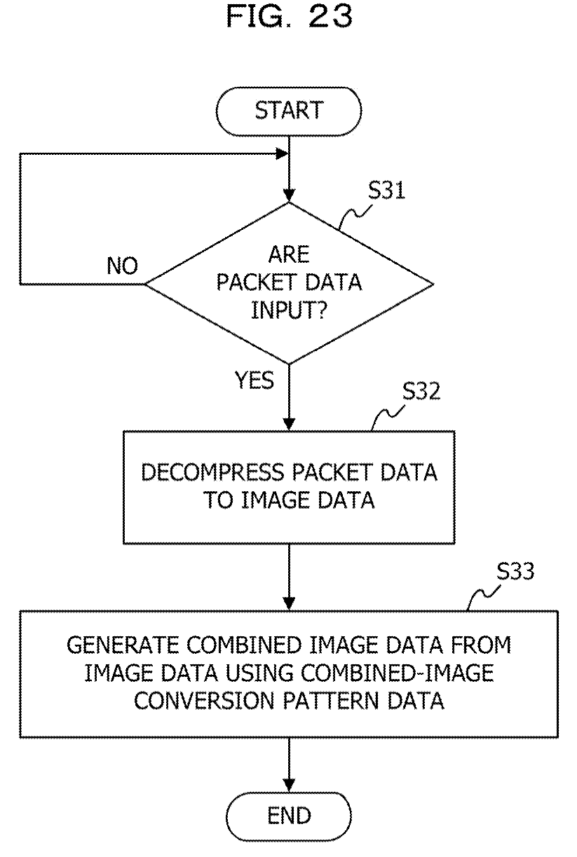

An operation procedure of the image processing system 1 will now be described with reference to flowcharts of FIGS. 22 and 23.

First, the control unit 230 determines whether an instruction to change of combined image is commanded through the operation unit 310 (operation S21). If the instruction to change the combined image is given (YES in operation S21), the control unit 230 notifies the image capture apparatus 100 of the change instruction. In response to the notification, the first to fourth image capture units 110, 120, 130 and 140 each record the instruction to change the combined image into a memory (operation S22).

Subsequently, when the cameras 111, 121, 131, and 141 capture images, and input image data into image compressing units 112,122,132, and 142 (YES in operation S23), the compression ratio control units 114, 124, 134, and 144 acquire segment importance degree pattern data for generation of a specified combined image from the control unit 230. The compression ratio control units 114, 124, 134, and 144 control compression ratios for the camera image data captured through the cameras 111, 121, 131, and 141 with reference to the acquired segment importance degree pattern data (operation S24). At this time, each of the compression ratio control units 114 to 144 changes the compression ratio for each segment in the image data in accordance with the corresponding importance degree included in the segment importance degree pattern data. The image compressing units 112, 122, 132, and 142 compress the image data and output to the network I/F units 113, 123, 133, and 143, respectively. The network I/F units 113 to 143 each generate data packets having a size depending on the amount of compressed image data of one frame and each transmit the packets to the image processing apparatus 200 (operation S25).

A procedure of the image processing apparatus 200 will now be described with reference to FIG. 23.

The image processing apparatus 200 receives data packets transmitted over the network 150 from the first to fourth image capture units 110, 120, 130 and 140 through the network I/F unit 210. When the network I/F unit 210 receives the data packets (YES in operation S31), the network I/F unit 210 decompresses the received packets data to image data (operation S32). The network I/F unit 210 adds blanking data to the decompressed image data and outputs the resultant data to the image generating unit 220. When receiving the image data from the network I/F unit 210, the image generating unit 220 converts (synthesizes) the image data into combined image data with reference to combined-image conversion pattern data stored in the storage unit 240 (operation S33).

As described above, in an embodiment, the compression ratio for each segment in image data is changed in accordance with the corresponding importance degree included in segment importance degree pattern data, and the compressed image data is transmitted to the image processing apparatus 200. Accordingly, while the amount of data transmitted from the image capture apparatus can be reduced, a high-quality combined image can be generated.

A method of image processing is provided including determining a degree of importance for segments of an image captured using multiple image capturing devices, adjusting resolutions of to the segments based on a corresponding degree of importance, and combining the segments with the adjusted resolutions to produce a resultant image. The method includes selectively adjusting resolutions of segments of the divided image based on a degree of importance assigned. Further, while specific examples of an image capturing device(s) of a vehicle are described herein, the present invention is not limited to use in relation to vehicles.

It should be understood that the present invention is not limited to the above-described embodiments and various changes and modifications thereof can be made without departing from the spirit and scope of the present invention.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention, the scope of which is defined in the claims and their equivalents.

What is claimed is:

1. An image processing system, comprising:
a display apparatus displaying image data;
a plurality of image capture units mounted on a vehicle and capturing images of surroundings of a vehicle; and
an image processing apparatus connected with the plurality of image capture units via a network in the vehicle to generate a combined image data based on a plurality of image data captured by the image capture units, and connected with the display apparatus, and
wherein the plurality of image capture units each include:
a camera capturing an image data of one of surrounding parts of the vehicle;
a storage unit storing segment information for identifying each of segments divided from the image data captured by the camera, and importance degrees calculated for the segments based on resolutions which are required of the segments in the image data upon generation of the combined image data;
an image compressing unit compressing each of the segments of the image data at a compression ratio depending on a corresponding importance degree for each of the segments, and generating compressed image data; and
a transmitting unit transmitting the compressed image data to the image processing apparatus through the network,
the image processing apparatus including:
a network interface unit inputting the compressed image data transmitted from each of the image capture units;
an image generating unit generating a combined image data based on the compressed image data; and
a transmitting unit transmitting the combined image data to the display apparatus, and
the display apparatus including:
a receiving unit receiving the combined image data transmitted from the image processing apparatus; and
a display unit displaying the combined image data.

2. The system according to claim 1, wherein the importance degrees stored in the storage unit in each of the image capture units are information calculated based on pixel scaling factors of pixels in the image data for conversion into the combined image data.

3. The system according to claim 2, wherein the pixel scaling factors are information corrected depending on a distance between the vehicle and a position corresponding to each pixel in the combined image data.

4. The system according to claim 1, wherein the transmitting unit of each image capture unit divides the image data into plurality of packet data so that a size of each packet data changes depending on an amount of the compressed image data, and transmits the packet data to the image processing apparatus.

5. The system according to claim 2, wherein the transmitting unit of each image capture unit divides the image data into plurality of packet data so that a size of the each packet data changes depending on an amount of the compressed image data, and transmits the packet data to the image processing apparatus.

6. The system according to claim 3, wherein the transmitting unit of each image capture unit divides the image data into plurality of packet data so that a size of the each packet data changes depending on the amount of the compressed image data, and transmits the packet data to the image processing apparatus.

7. An image capture unit capturing an image data of surroundings of a vehicle, connected with an image processing apparatus via network in the vehicle to generate a combined image data based on a plurality of image data, the image capture unit comprising:
a camera capturing an image data of one of surrounding parts of the vehicle;
a storage unit storing segment information for identifying each of segments divided from the image data captured by the camera, and importance degrees calculated for the segments based on resolutions which are required of the segments in the image data upon generation of the combined image data;
an image compressing unit compressing each of the segments of the image data at a compression ratio depending on a corresponding importance degree for each of the segments, and generating compressed image data; and
a transmitting unit transmitting the compressed image data to the image processing apparatus through the network.

8. The image capture unit according to claim 7, wherein the transmitting unit divides the image data into plurality of packet data so that a size of the each packet data changes depending on an amount of the compressed image data, and transmits the packet data to the image processing apparatus.

9. A method of image processing, comprising:
determining a degree of importance for segments of an image captured using multiple image capturing devices;
adjusting resolutions of to the segments based on a corresponding degree of importance; and
combining the segments with the adjusted resolutions to produce a resultant image. The method according to claim 9, comprising:
transmitting the resultant image, where a compression rate of the resultant image is changed in accordance with a corresponding degree of importance.
